(19) United States
(12) Patent Application Publication
(10) Pub. No.: US 2026/0116422 A1
(43) Pub. Date: Apr. 30, 2026

(54) CONTROL DEVICE AND METHOD FOR CONTROLLING A VEHICLE

(71) Applicants: Hyundai Motor Company, Seoul (KR); Kia Corporation, Seoul (KR)

(72) Inventor: Chan Hee JUNG, Hwaseong-Si (KR)

(21) Appl. No.: 19/350,740

(22) Filed: Oct. 6, 2025

(30) Foreign Application Priority Data
Oct. 25, 2024 (KR) 10-2024-0147629

(51) Int. Cl. B60W 60/00; B60W 40/08; B60W 50/00; B60W 50/14; G06V 20/59

(52) U.S. Cl. CPC B60W 60/001; B60W 40/08; B60W 50/14; G06V 20/597; B60W 2040/0818; B60W 2050/0083; B60W 2050/146; B60W 2420/403; B60W 2540/223; B60W 2540/225; B60W 2540/229; B60W 2556/45

(57) ABSTRACT

A device and method for controlling autonomous driving are provided. A driving automation device may include a processor and a memory storing: an engagement state of a driver of a vehicle; and control information associated with one or more autonomous driving functions of the vehicle. The memory may further store at least one instruction that is configured, when executed by the processor communicating with the memory, to cause the driving automation device to: recognize, via at least one sensor of the vehicle, the driver of the vehicle; evaluate, based on the control information associated with the one or more autonomous driving functions, the engagement state of the driver for an autonomous driving portion of a trip, of the vehicle, during which the one or more autonomous driving functions of the vehicle are activated; and control, based on the engagement state, the one or more autonomous driving functions of the vehicle.

### CROSS-REFERENCE TO RELATED APPLICATION

This application claims priority to Korean Patent Application No. 10-2024-0147629, filed on Oct. 25, 2024, the disclosure of which is incorporated herein by reference in its entirety.

### FIELD OF TECHNOLOGY

The present disclosure relates to an autonomous driving control device.

### BACKGROUND

Some jurisdictions impose requirements for driver monitoring for autonomous vehicles, and some also require measures to prevent inappropriate driver behavior during an autonomous driving session.

Accordingly, many vehicle manufacturers are adding manual training or the like on the use of autonomous driving, but at least some implementations of autonomous vehicle systems have a limitation in that it is difficult to automatically limit an autonomous driving-related function in the system when a driver's cumulative misuse continues to occur.

### SUMMARY

The present disclosure has been made to solve the aforementioned problem, and is directed to controlling an autonomous driving-related function by evaluating a user engagement state in a prolonged autonomous driving section and displaying the content of the evaluation and control to the user.

Problems to be solved by the present disclosure are not limited to those mentioned above, and other problems not mentioned will be clearly understood by those of ordinary skill in the art from the following description.

According to one or more example embodiments of the present disclosure, a driving automation device may include: a processor; and a memory storing: an engagement state of a driver of a vehicle; and control information associated with one or more autonomous driving functions of the vehicle. The memory may further store at least one instruction that is configured, when executed by the processor communicating with the memory, to cause the driving automation device to: recognize, via at least one sensor of the vehicle, the driver of the vehicle; evaluate, based on the control information associated with the one or more autonomous driving functions, the engagement state of the driver for an autonomous driving portion of a trip, of the vehicle, during which the one or more autonomous driving functions of the vehicle are activated; and control, based on the engagement state, the one or more autonomous driving functions of the vehicle.

The at least one instruction may be configured, when executed by the processor communicating with the memory, to cause the driving automation device to evaluate the engagement state of the driver by: evaluating the engagement state of the driver based on at least one of: a steering wheel grip status of the driver during the autonomous driving portion of the trip, or an eye gaze status of the driver during the autonomous driving portion of the trip.

The steering wheel grip status of the driver may indicate a grip region on a steering wheel of the vehicle and a grip strength of the driver on the steering wheel. The at least one instruction may be configured, when executed by the processor the processor communicating with the memory, to cause the driving automation device to evaluate the engagement state of the driver by applying different weights to the grip region and the grip strength.

The eye gaze status may indicate: a first time duration during which the driver gazed in a first direction toward a windshield of the vehicle, a second time duration during which the driver gazed in a second direction toward a mirror of the vehicle, and a third time duration during which the driver gazed in any third direction that is away from the first direction and the second direction. The at least one instruction may be configured, when executed by the processor the processor communicating with the memory, to cause the driving automation device to evaluate the engagement state of the driver by applying different weights to the first time duration, the second time duration, and the third time duration.

The at least one instruction may be configured, when executed by the processor communicating with the memory, to cause the driving automation device to evaluate the engagement state of the driver by evaluating the engagement state of the driver based on a number of warnings given to the driver during the autonomous driving portion of the trip.

The at least one instruction may be configured, when executed by the processor communicating with the memory, to further cause the driving automation device to: reset, based on a predetermined condition being satisfied, the engagement state of the driver.

The one or more autonomous driving functions may be associated with at least one of: a warning to the driver, an autonomous driving operational design domain (ODD) of the vehicle, steering the vehicle, accelerating the vehicle, or braking the vehicle.

The at least one instruction may be configured, when executed by the processor communicating with the memory, to further cause the driving automation device to: determine a plurality of autonomous driving ODDs of the vehicle, each autonomous driving ODD of the plurality of autonomous driving ODDs being associated with a different set of the one or more autonomous driving functions; and determine, based on the engagement state of the driver, whether to support at least one of the plurality of autonomous driving ODDs.

The at least one instruction may be configured, when executed by the processor communicating with the memory, to cause the driving automation device to evaluate the engagement state of the driver by: evaluating an engagement state for each sub-portion, of the autonomous driving portion, during which a corresponding autonomous driving function of the one or more autonomous driving functions was activated. The at least one instruction may be configured, when executed by the processor communicating with the memory, to cause the driving automation device to control the one or more autonomous driving functions of the vehicle by: controlling, based on the engagement state for each sub-portion of the autonomous driving portion, the corresponding autonomous driving function.

The at least one instruction may be configured, when executed by the processor communicating with the memory, to further cause the driving automation device to: display, via a user interface, at least one of the engagement state of the driver or an autonomous driving control state of the vehicle according to the engagement state.

The at least one instruction may be configured, when executed by the processor communicating with the memory, to cause the driving automation device to display the engagement state of the driver by: displaying, via the user interface, at least one of: a first indicator of a steering wheel grip status of the driver; a second indicator of an eye gaze status of the driver; a third indicator of a number of warnings given to the driver; or a fourth indicator of a value of the engagement state of the driver.

The at least one instruction may be configured, when executed by the processor communicating with the memory, to cause the driving automation device to: display, based on receiving a routing request for a destination, one or more routes to reach the destination. Each of the one or more routes may be associated with a corresponding autonomous driving function of the one or more autonomous driving functions.

The at least one instruction may be configured, when executed by the processor communicating with the memory, to further cause the driving automation device to: transmit, via a communication interface of the vehicle and to a terminal associated with the driver, at least one of the engagement state of the driver or an autonomous driving control state of the vehicle according to the engagement state.

According to one or more example embodiments of the present disclosure, a method performed by an apparatus of a vehicle may include: recognizing, via at least one sensor of the vehicle, a driver of the vehicle; evaluating, based on control information associated with one or more autonomous driving functions of the vehicle, an engagement state of the driver for an autonomous driving portion of a trip, of the vehicle, during which the one or more autonomous driving functions of the vehicle are activated; and controlling, based on the engagement state, one or more autonomous driving functions of the vehicle.

Evaluating the engagement state of the driver may include: evaluating the engagement state of the driver based on at least one of: a steering wheel grip status of the driver during the autonomous driving portion of the trip, or an eye gaze status of the driver during the autonomous driving portion of the trip.

The steering wheel grip status of the driver may indicate a grip region on a steering wheel of the vehicle and a grip strength of the driver on the steering wheel. Evaluating the engagement state of the driver may include applying different weights to the grip region and the grip strength.

The eye gaze status may indicate: a first time duration during which the driver gazed in a first direction toward a windshield of the vehicle, a second time duration during which the driver gazed in a second direction toward a mirror of the vehicle, and a third time duration during which the driver gazed in any third direction that is away from the first direction and the second direction. Evaluating the engagement state of the driver may include applying different weights to the first time duration, the second time duration, and the third time duration.

Evaluating the engagement state of the driver may include evaluating the engagement state of the driver based on a number of warnings given to the driver during the autonomous driving portion of the trip.

The method may further include: resetting, based on a predetermined condition being satisfied, the engagement state of the driver.

The one or more autonomous driving functions may be associated with at least one of: a warning to the driver, an autonomous driving operational design domain (ODD) of the vehicle, steering the vehicle, accelerating the vehicle, or braking the vehicle.

### BRIEF DESCRIPTION OF THE DRAWINGS

The above and other objects, features and advantages of the present disclosure will become more apparent to those of ordinary skill in the art by describing one or more example embodiments thereof in detail with reference to the accompanying drawings, in which:

FIG. 1 is a configuration diagram illustrating an autonomous driving control device;

FIG. 2 is a flowchart illustrating a method of controlling autonomous driving;

FIG. 3 is an example diagram of items for evaluating a driver engagement state;

FIG. 4 is an example view of an interior of a vehicle;

FIG. 5 is an example diagram of autonomous driving-related function items controlled;

FIG. 6 is a flowchart illustrating a specific method of controlling autonomous driving;

FIG. 7 is a flowchart of the operation for controlling an autonomous driving-related function for each driver score; and

FIGS. 8, 9, 10, and 11 are example views of screens that display autonomous driving-related functions to a driver.

### DETAILED DESCRIPTION

Hereinafter, one or more example embodiments of the present disclosure will be described in detail with reference to the accompanying drawings.

However, the technical idea of the present disclosure is not limited to the example embodiments as described herein but may be implemented in various different forms, and within the scope of the technical idea of the present disclosure, one or more among components in the example embodiments may be used by being selectively combined and substituted.

Further, unless specifically defined and described, terms used in the example embodiments of the present disclosure (including technical and scientific terms) may be interpreted as meanings which are generally understood by those skilled in the art to which the present disclosure pertains, and commonly used terms such as terms defined in the dictionary may be interpreted in consideration of the contextual meaning of the related art.

The terms used in the example embodiments of the present disclosure are for the purpose of describing the example embodiments only and are not intended to limit the disclosure.

In the present specification, the singular forms may include the plural forms unless the context clearly dictates otherwise. For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

In addition, in describing a component of example embodiments of the present disclosure, terms such as first, second, A, B, (a), (b), etc., may be used.

These terms are only for distinguishing the component from other components, and the essence, sequence, or order of the component is not limited by the terms.

In addition, when a component is described as being “linked,” “coupled,” or “connected” to another component, the component is not only directly linked, coupled, or connected to another component, but also “linked,” “coupled,” or “connected” to another component with still another component disposed between the component and the other component.

Further, when a component is described as being formed or disposed “on (above) or under (below)” of another component, the term “on (above) or under (below)” includes not only when two components are in direct contact with each other, but also when one or more of other components are formed or disposed between the two components. Further, when a component is described as being “on (above) or below (under),” the description may include the meanings of an upward direction and a downward direction based on one component.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., evaluating the engagement state of the driver) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., evaluating the engagement state of the driver) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., evaluating the engagement state of the driver) described herein.

Minimum risk maneuver (MRM) operation(s) may also be controlled, for example, based on one or more features (e.g., evaluating the engagement state of the driver) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., evaluating the engagement state of the driver) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., evaluating the engagement state of the driver) described herein.

An operation control for autonomous driving (e.g., controlling an autonomous driving function) of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, driver warning control, autonomous driving operational design domain (ODD) control, etc.).

An autonomous driving level and/or autonomous driving activation/deactivation may also be controlled, for example, based on one or more features (e.g., evaluating the engagement state of the driver) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

A “driver engagement state” mentioned in the present disclosure may refer to a degree of engagement, focus, concentration, and/or interest of a driver during or after the one or more sections (e.g., time spans or road segments) in which the autonomous driving mode (also referred to as autonomous driving state) of the vehicle was engaged. Thus, for example, a high degree of driver engagement may indicate that the driver is less distracted from one or more tasks required for one to operate the vehicle. The driver engagement states may include (e.g., be based on and/or measured by) various user behaviors, such as whether or not the driver is gripping (e.g., placing one or more hands on) the steering wheel, how firmly the driver is gripping the steering wheel, whether or not the driver is gazing at the front (e.g., ahead), etc.

An “autonomous driving-related function” mentioned in the present disclosure may be interpreted to include at least one of determining whether autonomous driving is supported by a system, outputting warnings (e.g., notifications) to a driver related to autonomous driving, controlling an autonomous driving operational design domain (ODD), controlling an autonomous driving operating feature, controlling an autonomous driving function mode, etc. An ODD may refer to an operating condition under which a given driving automation system or feature thereof is specifically designed to function. For example, ODDs may include environmental, geographical, and time-of-day restrictions, and/or the requisite presence or absence of certain traffic or roadway characteristics.

In the various flowcharts of the present disclosure, one or more operations may be omitted or performed in any other order. At least some of the example embodiments of the present disclosure may be performed at any particular or arbitrary point in each operation of the flowchart. Various flowcharts of the present disclosure may be performed by at least one of an autonomous driving control device (also referred to as a driving automation device or driving automation system) 100, a processor 130, a control unit, or a computer program.

In at least some implementations of autonomous vehicle systems, a problem may arise where a driver cannot actively improve his/her engagement state for autonomous driving because there is no technology to guide the driver regarding driver engagement state for the accumulative autonomous driving time.

Hereinafter, one or more example embodiments will be described in detail with reference to the accompanying drawings, but identical or corresponding components are denoted by the same reference numerals regardless of figure numbers, and redundant descriptions thereof will be omitted.

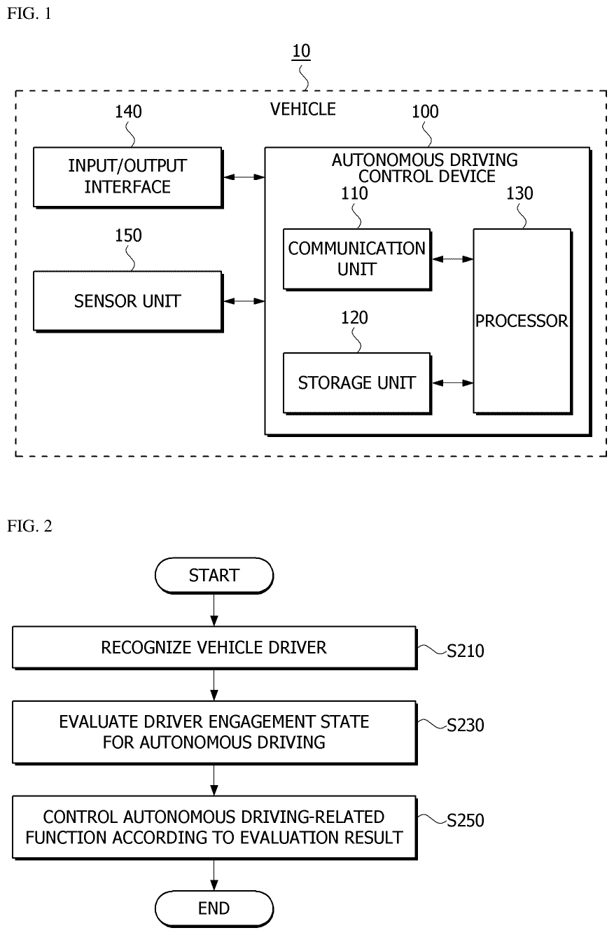

FIG. 1 is a configuration diagram illustrating an autonomous driving control device 100.

A vehicle 10 may include an autonomous driving control device (also referred to as autonomous driving controller) 100, a communication interface (also referred to as a communication unit) 110, storage (also referred to as a storage unit) 120, a processor 130, an input/output interface (also referred to as an input/output interface, a user interface, a human interface device (HID), etc.) 140, and one or more sensors (also referred to as a sensor unit, a sensor array, etc.) 150. Each of the components in FIG. 1 may be implemented inside the vehicle.

The autonomous driving control device 100 may be a hardware device, a software program, or a combination of both that controls autonomous driving-related functions according to a driver engagement state (also referred to as an engagement rating, a driver engagement rating, a focus rating, a driver focus rating, a driver distraction rating, etc.) for an accumulative autonomous driving section based on a specific driver. The term “section” as used herein may referred to a length (e.g., span) in time and/or space. In other words, the accumulative autonomous driving section may refer to either a total time span (e.g., duration) during which the autonomous driving mode of the vehicle was engaged (e.g., activated) or a total distance traveled by the vehicle with the autonomous driving mode of the vehicle engaged (e.g., activated). Thus, the accumulative autonomous driving section may refer to the sum of all time durations (e.g., non-contiguous time spans) or all spatial distances (e.g., non-contiguous road segments) for which the autonomous driving mode was engaged. The accumulative autonomous driving section may be the portion(s) of the vehicle's trip where the autonomous driving mode was engaged. An autonomous driving section may also be referred to as an autonomous driving portion, for example, of a trip. A trip of the vehicle may refer to a single drive or journey of the vehicle from an origin to a destination. There may be no waypoints between the original and the destination in a single trip, or there may be one or more waypoints between the original and the destination in a single trip. Alternatively, a trip of the vehicle may refer to a span of time or distance that starts when the vehicle starts operating (e.g., an engine of a vehicle is switched or an electric vehicle is switched on) and ends when the vehicle stops operating (e.g., an engine of a vehicle is switched off or an electric vehicle is switched off). The autonomous driving control device 100 may be formed integrally with internal components of the vehicle, or may be implemented as a separate device and connected to the internal components of the vehicle by a separate connecting device. The autonomous driving control device 100 may be illustrated as including the communication interface 110, the storage 120, and the processor 130, but may also be configured to include other components of the vehicle 10 (e.g., input/output interface 140 and the like).

The communication interface 110 may communicate with a user terminal, another vehicle, or an external server. The communication interface 110 may perform short range communication, global positioning system (GPS) signal reception, vehicle-to-everything (V2X) communication, optical communication, broadcast transmission and reception, and intelligent transport systems (ITS) communication functions. The communication interface 110 may support short range communication using at least one of Bluetooth, radio frequency identification (RFID), Infrared Data Association (IrDA), ultra-wideband (UWB), ZigBee, near field communication (NFC), Wi-Fi, Wi-Fi Direct, and wireless Universal Serial Bus (wireless USB) technologies.

The storage 120 may store data generated or collected from at least some of components related to a map database (DB), driver engagement state evaluation of the vehicle 10, and control of the autonomous driving-related function. For example, the storage 120 may include a memory in which information related to the driver engagement state and control information regarding autonomous driving-related functions are stored. The storage 120 may be provided inside the processor 130 or the autonomous driving control device 100, or may be a separate memory. The storage 120 may be constituted by a combination of a non-volatile memory such as a hard disk drive, a flash memory, an electrically erasable programmable read-only memory (EEPROM), a static RAM (SRAM), a ferro-electric RAM (FRAM), a phase-change RAM (PRAM), a magnetic RAM (MRAM), or the like, and/or a volatile memory such as a dynamic random access memory (DRAM), a synchronous dynamic random access memory (SDRAM), a double date rate-SDRAM (DDR-SDRAM), or the like.

The processor 130 may be electrically connected to the communication interface 110, the storage 120, the input/output interface 140, the one or more sensors 150, and various internal components of the vehicle 10, may electrically control each component, and may be an electric circuit that executes software commands, thereby performing various data processing and calculations described below.

The processor 130 may process a signal transmitted between each component of the vehicle 10, and perform overall control so that each component may normally perform its function. The processor 130 may be implemented in the form of hardware, in the form of software, or in the form of a combination of hardware and software. In addition, the autonomous driving control device 100 may include at least one processor 130.

The input/output interface 140 may include an input unit for receiving a control command from the user and an output unit for outputting an operation state, result, and the like, of the autonomous driving control device 100. Here, the input unit may include physical keys (e.g., physical buttons) and soft keys implemented on a touch display.

The output unit may include a display, and may further include a voice output device such as a speaker, and a haptic module that generates vibration. In this case, if a touch sensor, such as a touch film, a touch sheet, a touch pad, or the like, is provided on the display, the display may operate as a touch screen, and may be implemented in a form in which the input unit and the output unit are integrated.

The input/output interface 140 may be implemented as a physical button, a display, a head-up display (HUD), a cluster, an audio video navigation (AVN), a human machine interface (HMI), a user setting menu (USM), or the like. In addition, the display may be included in a rear-view mirror or a side mirror.

For example, the user may request operations and displays related to the driver engagement state evaluation and the autonomous driving-related function control through physical buttons of the cluster or a display of the AVN as the input unit. In addition, the vehicle 10 may receive an input or output a screen through a display on a console positioned in a second or third row of the vehicle, or through a display of an application implemented on a user terminal.

The one or more sensors 150 may include at least one of a radio detection and ranging (RADAR) sensor, a light imaging detection and ranging (LIDAR) sensor, a fingerprint recognition sensor, a retina recognition sensor, an iris recognition sensor, a camera, a steering wheel grip sensor, a pressure sensor, a position sensor (e.g., GPS and the like), an ultrasonic sensor, a heart rate sensor, a light sensor, a pressure-sensitive sensor, a motion sensor, a seating sensor, and an infrared sensor. The camera may include an exterior camera for monitoring the exterior of the vehicle and an interior camera for detecting an object, such as a driver, inside the vehicle.

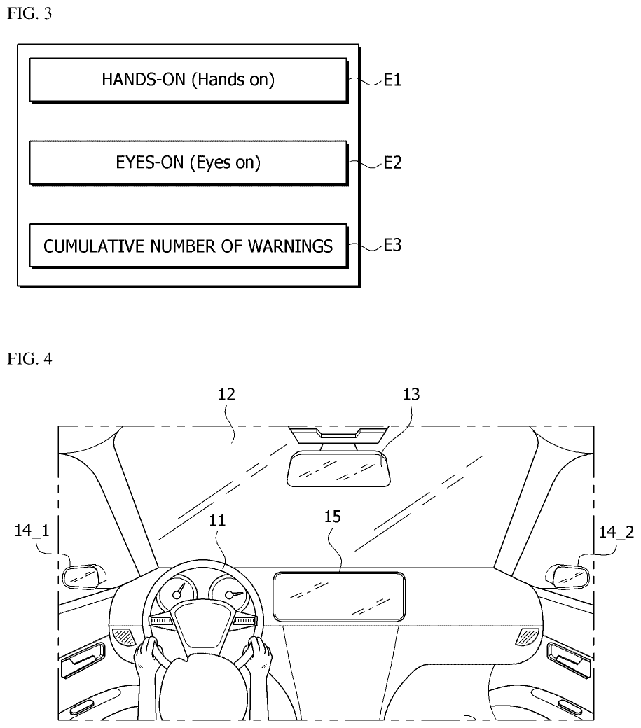

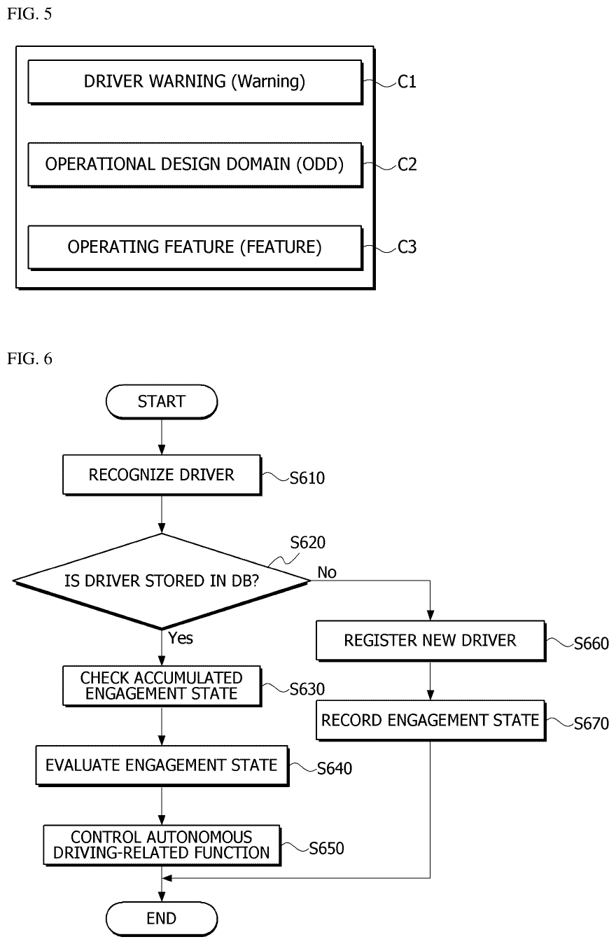

FIG. 2 is a flowchart illustrating a method of controlling autonomous driving. For description of FIG. 2, the method will be described with reference to FIGS. 3 through 5. FIG. 3 is an example diagram of items for evaluating a driver engagement state, and FIG. 4 is an example view of an interior of the vehicle. FIG. 5 is an example diagram of autonomous driving-related function items controlled.

The autonomous driving control device 100 may recognize a vehicle driver (S210). For example, the processor 130 may determine the driver as driver A, driver B, or driver C by distinguishing the driver. The autonomous driving control device 100 may collect a driver's facial image or video through a camera and recognize the collected image or video to distinguish the driver. For example, the autonomous driving control device 100 may distinguish and recognize the driver using a deep learning tool such as a convolutional neural network (CNN). However, the autonomous driving control device not limited thereto, and may also recognize the driver through methods such as user authentication such as fingerprints or the like, communication with a user terminal, and checking information collected through input by the user and information stored in advance. Information on the recognized driver may be classified (e.g., identified, detected, etc.) based on driver information and stored in the storage 120.

The autonomous driving control device 100 may evaluate a driver engagement state (S230).

The autonomous driving control device 100 may confirm (e.g., determine) an accumulative driving section (e.g., time) for the recognized user (e.g., the total time for which the vehicle was operated with the recognized user seated in in the driver's seat of the vehicle). The autonomous driving control device 100 may distinguish between a normal driving section (e.g., a portion of a trip of the vehicle during which autonomous driving was not active or engaged) and an autonomous driving section (e.g., a portion of a trip of the vehicle during which autonomous driving was active or engaged) by the vehicle system among the accumulative driving sections (e.g., an entire length of the trip of the vehicle) of the recognized driver.

The autonomous driving control device 100 may evaluate the user engagement state for the autonomous driving section (e.g., time) in a total accumulative driving section (e.g., time). The autonomous driving control device 100 may store and evaluate the user engagement state by distinguishing between a case where the vehicle is in the autonomous driving mode in an autonomous driving section of the road and a case where the vehicle is not in the autonomous driving mode in a general driving section of the road.

For example, the autonomous driving control device 100 may extract (e.g., determine) engagement state information for N hours of the accumulative general driving section and engagement state information for M hours of the accumulative autonomous driving section for the corresponding driver from the database of the memory.

The autonomous driving control device 100 may confirm pieces of information regarding the accumulative engagement state that matches the recognized driver in the storage 120 and evaluate the driver engagement state based on the information regarding the accumulative engagement state.

The processor 130 may evaluate the driver engagement state based on at least one of a hands-on (E1) state of the driver, an eyes-on (E2) state of the driver, and a cumulative number of warnings (E3) given to the driver during the autonomous driving section, as factors illustrated in FIG. 3. In addition, the autonomous driving control device 100 may calculate an evaluation result in the form of scoring or grades (e.g., levels).

For example, referring to FIG. 4, the autonomous driving control device 100 may confirm whether the user is gripping a steering wheel 11 well during the autonomous driving section. For example, the autonomous driving control device 100 may evaluate the hands-on state (also referred to as a steering wheel grip status) based on at least one of a grip region and a grip strength of the driver on the steering wheel 11 of the vehicle. The grip region may be subdivided and classified as one-hand grip or two-hand grip depending on a way in which the user grips the steering wheel.

For example, in the hands-on state, an evaluation may be made in the following manner according to a portion for each hands-on strength (e.g., grip strength).

| Factor | Detail |
|---|---|
| X1 | The amount of time, out of the total time of the autonomous |
| | driving section (M), during which the driver has performed |
| | at least a weak one-hand grip (e.g., 5N of grip strength |
| | or greater) but not a strong one-hand grip (e.g., 10N |
| | of grip strength or greater) |
| X2 | The amount of time, out of the total time of the autonomous |
| | driving section (M), during which the driver has performed |
| | at least a strong one-hand grip (e.g., 10N of grip strength |
| | or greater) but not a two-hand grip, out of the total time |
| | of the autonomous driving section (M) |
| X3 | The amount of time, out of the total time of the autonomous |
| | driving section (M), during which the driver has performed |
| | at least a two-hand grip, out of the total time of the |
| | autonomous driving section (M) |

In the table, the weak grip and the strong grip may be distinguished by a measure of pressure or force, such as Newton (N). For example, the weak grip may correspond to a grip strength between 5 N and 10 N, and the strong grip may correspond to at least 10 N of grip strength, but the weak and strong grips are not limited to these specific example values. The grip and grip pressure (or grip force) on the steering wheel 11 as described above may be sensed through a steering wheel grip sensor (not shown) and/or a pressure sensor (not shown) included in the steering wheel 11.

The autonomous driving control device 100 may evaluate the driver engagement state by applying different weights (e.g., weight values) to one-hand grip, two-hand grip, and grip strength.

For example, the scoring of driver engagement evaluation according to the table may be determined as follows.

Engagement evaluation score (P_{hands on})=w₁X₁+w₂X₂+w₃X₃ (where w₁,w₂, and w₃ are weight values corresponding to factors X₁,X₂, and X₃, respectively, and wᵢ≤w₂≤w₃,0≤wₖ≤1)

The autonomous driving control device 100 may confirm (e.g., determine) the eyes-on (E2) state (also referred to as an eye gaze status) indicating where the user's (e.g., driver's) eyes are looking during the autonomous driving section.

For example, as an example of evaluating the eyes-on state, the evaluation may be performed in the following manner depending on a direction of the driver's gaze. In this case, the direction of the driver's gaze may be confirmed (e.g., determined) through the one or more sensors 150 such as at least one indoor camera.

| Factor | Detail |
|---|---|
| Y1 | The amount of time, out of the total time of the autonomous |
| | driving section (M), the driver has spent gazing at a |
| | display device of the vehicle (e.g., the AVN display |
| | or other displays) |
| Y2 | The amount of time, out of the total time of the autonomous |
| | driving section (M), the driver has spent gazing at a side |
| | mirror and a rear-view mirror |
| Y3 | The amount of time, out of the total time of the autonomous |
| | driving section (M), the driver has spent gazing at |
| | the windshield |

For example, referring to FIG. 4, in the autonomous driving section, the driver may look in a first direction including a windshield 12, a second direction including mirrors 13, 14_1, and 14_2 of the vehicle, and a third direction of looking elsewhere (e.g., a display 15 or the like).

The autonomous driving control device 100 may evaluate the driver engagement state by applying different weights to the first direction (e.g., a first time duration during which the driver gazed in the first direction), the second direction (e.g., a second time duration during which the driver gazed in the second direction), and the third direction (e.g., a third time duration during which the driver gazed in the third direction).

For example, if the driver looks in the first direction including the windshield 12, it may be determined that the driver is gazing forward. Therefore, if the driver looks in the first direction, the autonomous driving control device 100 may perform the eyes-on evaluation with the highest weight.

Referring to the table, the eyes-on engagement evaluation score of the driver may be calculated as an example below.

Engagement evaluation score (P_{eyes on})=w₁Y₁+w₂Y₂+w₃Y₃ (where w₁≤w₂≤w₃,0≤wₖ≤1)

As shown in the calculating equation, the autonomous driving control device 100 may evaluate the driver engagement state by applying different weights to the first direction, the second direction, and the third direction.

The autonomous driving control device 100 may evaluate the driver engagement state based on the cumulative number of warnings given to the driver.

For example, the autonomous driving control device 100 may request user intervention (e.g., gripping the steering wheel, looking ahead, and so on) necessary for autonomous driving by a preset vehicle autonomous driving system during an accumulative section (M) in which the autonomous driving function is in operation, and may output a warning if the user intervention is not performed.

The autonomous driving control device 100 may evaluate the driver engagement state by applying different weights according to the cumulative number of warnings, as follows.

| Factor | Detail |
|---|---|
| Z1 | The number of times, while the vehicle was in the autonomous |
| | driving section (M), the driver has received a first |
| | engagement warning |
| Z2 | The number of times, while the vehicle was in the autonomous |
| | driving section (M), the driver has received a second |
| | engagement warning |
| Z3 | The number of times, while the vehicle was in the autonomous |
| | driving section (M), the driver has received a third |
| | engagement warning |

The scoring of the engagement evaluation according to the table may be exemplarily calculated as follows.

Engagement evaluation score (P_{warning})=−(w₁Z₁+w₂Z₂+w₃Z₃) (where w₁≤w₂≤w₃,0≤wₖ≤1)

The autonomous driving control device 100 may calculate a final evaluation score P_{final} as follows based on the P_{hands on}, P_{eyes on}, and P_{warning} values as described above.

$$( {P}_{final} ) = ( {P}_{hands on} ) + ( {P}_{eyes on} ) - ( {P}_{warning} )$$

In addition, the autonomous driving control device 100 may also determine a grade (e.g., level) indicating the user engagement state based on the final evaluation score calculated as above.

The autonomous driving control device 100 may distinguish and store the driver engagement state according to a plurality of references. For example, the engagement state may be classified (e.g., identified, detected, etc.) and stored depending on the type of driving road (e.g., highway/general road, number of lanes, or lane number). For example, the engagement state may be classified (e.g., identified, detected, etc.) and stored according to whether a surrounding road is congested or by driving speed. For example, the engagement state may be classified (e.g., identified, detected, etc.) and stored by driving position by a GPS position or the like. For example, the engagement state may be classified (e.g., identified, detected, etc.) and stored by specific autonomous driving function (e.g., the lane change by the system or the like).

The autonomous driving control device 100 may distinguish and determine the engagement state depending on the driving position of the driver, the type of driving road (e.g., highway, general road, intersection, tunnel, or the like), the state of a specific function while driving (e.g., driving speed, whether lanes are changed, or hands-on), and a road condition such as driving road traffic congestion, or the like, which are classified (e.g., identified, detected, etc.) and stored as described above.

In this case, the autonomous driving control device 100 may request a score or grade (e.g., level) of a specific engagement state level from the driver for a specific operating feature or a specific driving road type.

For example, the autonomous driving control device 100 may evaluate the engagement state in a tunnel, which is a specific autonomous driving section using only autonomous driving data in the tunnel, and calculate an evaluated result as a score or grade (e.g., level). In addition, the autonomous driving control device 100 may compare the calculated score or grade (e.g., level) with a score or grade set to be generally required in the tunnel.

The autonomous driving control device 100 may evaluate the driver engagement state using deep learning.

The autonomous driving control device 100 may learn data on a general driving section in a total accumulated driving section of the driver using a deep learning method, and may evaluate the user engagement state based on the learned content. For example, the autonomous driving control device 100 may set training data for general driving sections that may be used as a reference for evaluating the driver engagement state as reference data, and then compare the contents of learning data for the autonomous driving section with the reference data. Thereby, the driver engagement state may be evaluated even without applying a predetermined absolute weight. Without being limited thereto, the reference data may also be driver engagement state data learned to conform to a preset policy.

The evaluation of driver engagement state using the deep learning method as described above may be linked to at least one of the operational design domain (ODD) and operating feature. For example, the autonomous driving control device 100 may learn about specific operational design domain (ODD) information about the driver or specific operating feature of the driver as training data. In this way, it may be possible to determine a relative weight in the corresponding driving situation, and to calculate a reference value for comparing and evaluating the specific engagement state based on the determined weight.

The autonomous driving control device 100 may reset (e.g., initialize) an engagement evaluation score of the driver if a predetermined condition is met. The predetermined condition may be, for example, a condition such as specific training and evaluations associated with the specific training, but may also include any procedure that requires a user to actively intervene (e.g., activating a user control such as turning a steering wheel, depressing a pedal, pressing a button, turning a knob, moving a stalk, etc.) in the autonomous driving.

The autonomous driving control device 100 may update a driver engagement evaluation score at any time point. For example, if the autonomous driving control device 100 performs the autonomous driving function in the same mode, the autonomous driving control device 100 may update the engagement evaluation score and provide the updated score to the driver after the autonomous driving function of the corresponding mode is completed.

The autonomous driving control device 100 may control the autonomous driving-related function according to an evaluation result (S250).

As illustrated in FIG. 5, the autonomous driving control device 100 may vary or control at least one of a warning (C1) given to the driver related to autonomous driving, an operational design domain (ODD) (C2), an autonomous driving operating feature (C3), and an autonomous driving mode. In addition, the autonomous driving control device 100 may determine a longitudinal control amount, a lateral control amount, or the like, according to the autonomous driving-related function.

A control function related to the driver warning C1 may include control of variability of a starting time point of the warning, variability of a warning level and method, variability of a time point of lifting the warning, and the like.

For example, the variability of the starting time point of warning means that the time point at which the driver is warned is variable. For example, if a warning of an eyes-on request (EOR) or a warning of a hands-on request (HOR) has to be provided to the driver within a maximum of t seconds, the autonomous driving control device 100 may provide a related warning at t−k seconds if the evaluated driver engagement state result is lower than a predetermined value. Conversely, if the evaluated driver engagement state result is higher than the predetermined value, the autonomous driving control device 100 may provide the related warning at t seconds according to existing regulations.

In addition, if there is a preset event of which the driver has to be warned with a hands-on request in front of [x] m, the autonomous driving control device 100 may perform a pre-warning in front of [x+k] m in advance.

The variability of the warning level and method may mean that, for example, a primary warning is omitted or the driver is notified of an additional secondary warning in a warning situation according to the same event. For example, in the warning for the eyes-on request or hands-on request of the driver, in a first level, the warning may be a visual-based notification such as a display notification, while in a second level, an auditory, that is, audio-based notification or a tactile-based vibration notification may be output together with the visual notification.

In addition, according to autonomous driving regulations, if there is a transition from the first level notification to the second level notification, the escalation of the warning level may vary depending on results of the engagement state evaluation. For example, if the first level notification (e.g., visual notification) is output to the driver, and the second level notification (e.g., visual and auditory notification) is output after t seconds as the vehicle system detects a specific event, a driver with an engagement state score lower than or equal to a given value may be subject to the warning transition after t−k seconds.

The variability of the time point of lifting the warning means that a condition for lifting the warning is variable. For example, if a preset hands-on satisfaction condition is t seconds or more after gripping the steering wheel, and the engagement state score of a driver is low, the hands-on satisfaction condition may be changed to t+k seconds after gripping the steering wheel. For example, if a preset eyes-on satisfaction condition is to maintain forward gaze (e.g., if the user's gaze is detected as directed at the windshield) for t seconds or more, the condition may be changed to require that forward gaze be maintained for t+k seconds or more if the engagement state score of the driver is low.

The autonomous driving control device 100 may vary or control the operational design domain (ODD) (C2) depending on the driver engagement state.

As an example of the variability of the ODD, the autonomous driving control device 100 may limit (e.g., prevent activation of) the autonomous driving function of the vehicle in one or more specific road types, such as a highway, a general road (also referred to as a local road or a local street), a collector road, an arterial road, an expressway (also referred to as a freeway), a road without lanes (also referred to as an undivided highway), an unpaved road (e.g., a gravel road, a dirt road, etc.) a tunnel, an overpass, a bridge, a junction (JC), an interchange (IC), a toll road, a tollgate, an intersection, a crosswalk, and the like.

The autonomous driving control device 100 may classify and grade a risk level for each ODD. For example, Group A may include a tollgate, a road without lanes, an intersection, and a crosswalk. Group B may include a JC, an IC, and a general road. Group C may include a highway and an expressway.

The autonomous driving control device 100 may determine the ODD classified (e.g., identified, detected, etc.) by grade (e.g., level) as described above based on the driver engagement evaluation score. For example, if the driver engagement evaluation score is greater than or equal to value a (e.g., a first threshold value), the autonomous driving control device 100 may support autonomous driving in all of Groups A, B, and C. For example, if the driver engagement evaluation score is lower than value a and greater than or equal to value b (e.g., a first threshold value), the autonomous driving control device 100 may support the autonomous driving in Groups B and C. For example, if the driver engagement evaluation score is lower than value b, the autonomous driving control device 100 may support the autonomous driving only in Group C.

The autonomous driving control device 100 may vary or control the autonomous driving operating feature (C3) depending on the driver engagement state. The variability of the autonomous driving operating feature may be, for example, a method of limiting functions supported by autonomous driving. The autonomous driving function may include limiting or controlling features of operating speed, lane changes by the system, hands-free, automatic application, U-turn driving, and the like.

For example, the autonomous driving control device 100 may confirm (e.g., determine) an evaluation result, such as a score, grade (e.g., level), or the like, evaluated for a specific user and distinguish and control the operating feature of the vehicle based on the checked result. For example, if the score for a specific user A is lower than or equal to a predetermined value, the autonomous driving control device 100 may not provide the lane change function by the system among the autonomous driving functions, and may only support a longitudinal control function. In addition, if a notification has to be output t seconds before the execution of a specific function preset by autonomous driving regulations, an additional warning notification may be provided to user A t−k seconds in advance.

the autonomous driving control device 100 may classify (e.g., identify, detect, etc.) a plurality of operating features into at least one group according to the risk level, and determine whether to support at least one of the divided (e.g., classified) groups according to the evaluated driver engagement state.

Specifically, the autonomous driving control device 100 may divide (e.g., classify) and grade the difficulty and risk level of each autonomous driving operating feature.

For example, operating features such as U-turn, an automatic overtaking function, and vehicle speed of [x₁] km/h or higher by a system operation may be assigned to Group A. In addition, operating features such as lane change by a driver request, a hands-free mode, and vehicle speed of [x₂] km/h or higher but lower than [x₁] km/h by the system operation may be assigned to Group B. In addition, operating features of vehicle speed of [x₃] km/h or higher and lower than [x₂] km/h by the system operation may be assigned to Group C.

The autonomous driving control device 100 may support at least one of the groups divided (e.g., classified) as described above, depending on the driver engagement state evaluation. For example, if the driver engagement evaluation score is greater than or equal to value a, the autonomous driving control device 100 may support the autonomous driving operating feature for all of Groups A, B, and C. For example, if the driver engagement evaluation score is lower than value a and greater than or equal to value b, the autonomous driving control device 100 may support the autonomous driving operating feature for Groups B and C. For example, if the driver engagement evaluation score is lower than value b, the autonomous driving control device 100 may support the autonomous driving operating feature only for Group C.

The autonomous driving control device 100 may generate a plurality of groups that are distinguished from each other by combining the operational design domain (ODD) and the autonomous driving operating feature, and determine whether to support at least one of the generated groups based on the evaluated driver engagement state.

Specifically, the autonomous driving control device 100 may generate a plurality of groups that are distinguished from each other by combining the operational design domain (ODD) and autonomous driving operating feature as shown in the table below.

TABLE 1

| | | Automatic | Manual | | |
|---|---|---|---|---|---|
| | Operating | lane | lane | Hands- | Automatic |
| | speed | change | change | free | overtaking |
| Highway | Group 3 | Group 3 | Group 2 | Group 3 | Group 2 |
| JC/IC | Group 2 | Group 2 | Group 1 | Group 2 | Group 1 |
| Intersection | Group 1 | Group 1 | Group 2 | Group 2 | Group 1 |

The autonomous driving control device 100 may determine whether to support at least one of the generated groups based on the evaluated driver engagement state.

For example, if the driver engagement evaluation score is greater than or equal to value a, the autonomous driving control device 100 may support the autonomous driving and autonomous driving operating feature for all of Groups A, B, and C. For example, if the driver engagement evaluation score is lower than value a and greater than or equal to value b, the autonomous driving control device 100 may support the autonomous driving and autonomous driving operating feature for Groups B and C. For example, if the driver engagement evaluation score is lower than value b, the autonomous driving control device 100 may support the autonomous driving and autonomous driving operating feature only for Group C.

The autonomous driving control device 100 may evaluate the driver engagement state for the autonomous driving for each sub-section (e.g., driving road type, etc.) of the autonomous driving section, and control the autonomous driving-related function for each sub-section according to an evaluated result.

For example, if the driver engagement state is evaluated as low only in a tunnel, the autonomous driving control device 100 may limit the autonomous driving-related function only in the corresponding tunnel.

The autonomous driving control device 100 may evaluate the driver engagement state for the autonomous driving for each autonomous driving operating feature and control the autonomous driving-related function according to an evaluated result.

FIG. 6 is a flowchart illustrating a specific method of controlling autonomous driving. The contents in FIG. 6 that overlaps with the contents in FIG. 2 may be omitted.

The autonomous driving control device 100 may recognize a specific driver (S610), and may check whether the recognized driver is a driver stored in the DB (S620).

Specifically, the autonomous driving control device 100 may check whether the recognized driver is in the list of drivers stored in the memory. If the recognized driver is not in the list of the database (No in S620), the autonomous driving control device 100 may add the recognized driver to the list as a new driver (S660). In this case, the newly registered driver may be assigned an initial score or initial grade (e.g., level), and an engagement state may be recorded based on subsequent driving (S670).

If the recognized driver is a driver stored in the database (Yes in S620), the autonomous driving control device 100 may check the engagement state accumulated for the driver (S630), evaluate the engagement state (S640), and control the autonomous driving-related function (S650).

The autonomous driving control device 100 may delete the driver in the list from the list if the driver has not driven for a predetermined amount of time or more even after a predetermined period of time has elapsed.

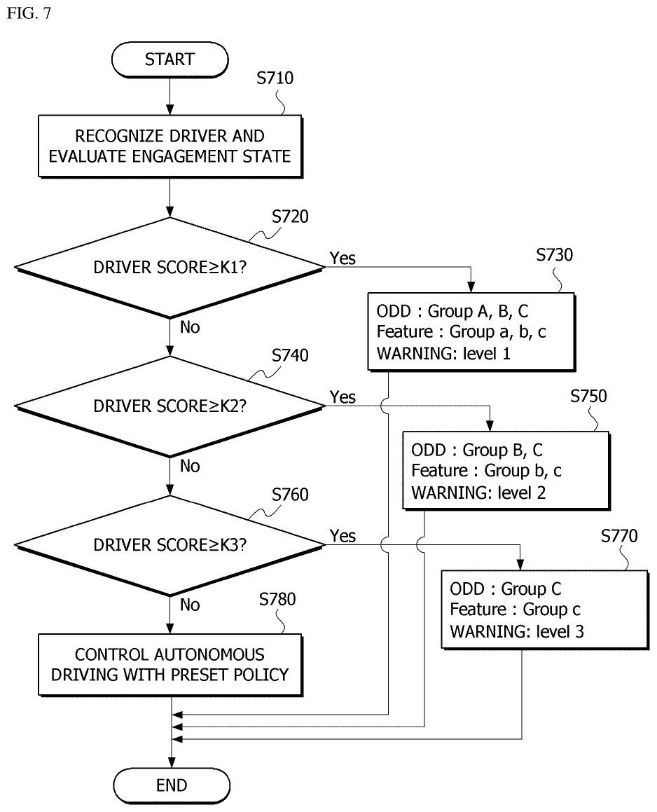

FIG. 7 is a flowchart of the operation for controlling an autonomous driving-related function for each driver score. The contents in FIG. 7 that overlaps with the contents in FIG. 6 and FIG. 2 may be omitted.

The autonomous driving control device 100 may recognize a driver and evaluate a driver engagement state (S710). Then, the autonomous driving control device 100 may compare the evaluated driver score with predetermined values. The predetermined values may be set, for example, in descending order of scores, as a first value K1, a second value K2, and a third value K3. In addition, the level of warning may be determined in ascending order as level 1, level 2, and level 3.

The autonomous driving control device 100 may determine whether the evaluated driver score is greater than or equal to the first value K1 (S720). If the evaluated driver score is greater than or equal to the first value K1 (Yes in S720), the autonomous driving control device 100 may support preset operational design domains (ODD) of all Groups A, B, and C to the corresponding driver in operation S730, and support the autonomous driving operating feature of the preset Group a, b, and c modes. In addition, the warning may be output only at level 1.

The autonomous driving control device 100 may determine whether the evaluated driver score is greater than or equal to the second value K2 (S740). That is, the autonomous driving control device 100 may determine whether the evaluated driver score is greater than or equal to the second value K2 and lower than the first value K1. If the evaluated driver score is greater than or equal to the second value K2 (Yes in S740), the autonomous driving control device 100 may support the preset operational design domains (ODD) of Groups B and C to the driver in operation S750, and support the autonomous driving operating feature of the preset Group b and c modes. In addition, the warning may be raised to level 2 and output.

The autonomous driving control device 100 may determine whether the evaluated driver score is greater than or equal to the third value K3 (S760). That is, the autonomous driving control device 100 may determine whether the evaluated driver score is greater than or equal to the third value K3 and lower than the second value K2. If the evaluated driver score is greater than or equal to the third value K3 (Yes in S760), the autonomous driving control device 100 may support the preset operational design domain (ODD) of Group C to the driver in operation S770 and support the autonomous driving operating feature of the preset Group c mode. In addition, the warning may be raised to level 3 and output.

If the evaluated driver score is lower than the third value K3 (No in S760), the autonomous driving control device 100 may control the autonomous driving-related function with a preset policy (S780). For example, if the driver score is too low, the autonomous driving control device 100 may stop the autonomous driving and request that driving is handed over to the user.

Through FIGS. 2 through 7 as illustrated above, the contents of recognizing a user, evaluating an engagement state of the recognized user, and controlling an autonomous driving-related function based on the evaluated engagement state have been disclosed. FIGS. 8 through 11 show example contents being output to the user (e.g., the driver). The autonomous driving control device 100 may provide the same contents as the contents of FIGS. 8 through 11 through the input/output interface (also referred to as a user interface) 140 at any operation (e.g., the last operation) of FIGS. 2, 6, and 7 described above. For example, the contents related to FIGS. 8 through 11 may be displayed through the AVN display 15, cluster, or head-up display in the windshield 12 in FIG. 8, but are not limited thereto, and may be output in the form of images, text, audio, vibration, and the like, through various devices.

FIGS. 8 through 11 are example view of screens that display autonomous driving-related functions to a driver.

The autonomous driving control device 100 may provide information related to autonomous driving-related functions. In addition, the autonomous driving control device 100 may provide an evaluation result of an engagement state of a corresponding driver.

Specifically, the autonomous driving control device 100 may display at least one of a first indicator indicating a hands-on state of the driver, a second indicator indicating an eyes-on state of the driver, a third indicator indicating a cumulative number of warnings given to the driver, and a fourth indicator indicating a score or grade (e.g., level) of the driver engagement state to be distinguished from each other.

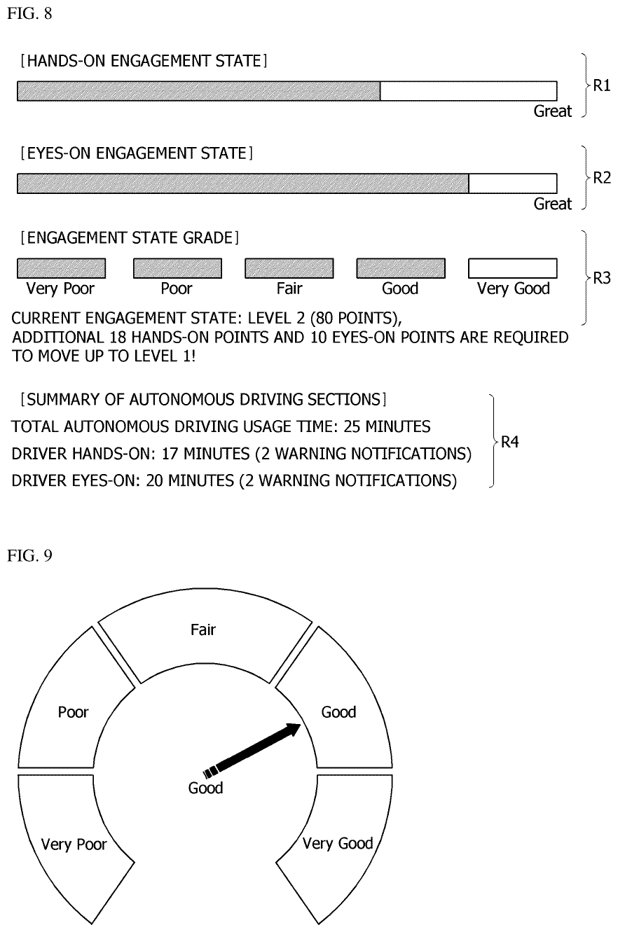

For example, looking at FIG. 8, the autonomous driving control device 100 may display a hands-on engagement state R1, an eyes-on engagement state R2, and an engagement state grade (e.g., level) R3 through the input/output interface 140. In addition, the autonomous driving control device 100 may provide summary information R4 including a cumulative number of warnings in the autonomous driving section. The autonomous driving control device 100 may display an engagement state score and grade (e.g., level) in a bar shape as in FIG. 8, or may display the score and grade (e.g., level) in a circle as in FIG. 9.

The screens as shown in FIGS. 8 and 9 may be provided at the end of operation or at any time point. However, without being limited thereto, the autonomous driving control device 100 may provide the driver with the engagement state score if the vehicle is stopped in a park (P) stage or if the vehicle is turned on/off. FIG. 8 as shown above or score provision may be displayed through the display within the vehicle or transmitted to a terminal of the driver. In addition, the score is provided based on the currently recognized driver.

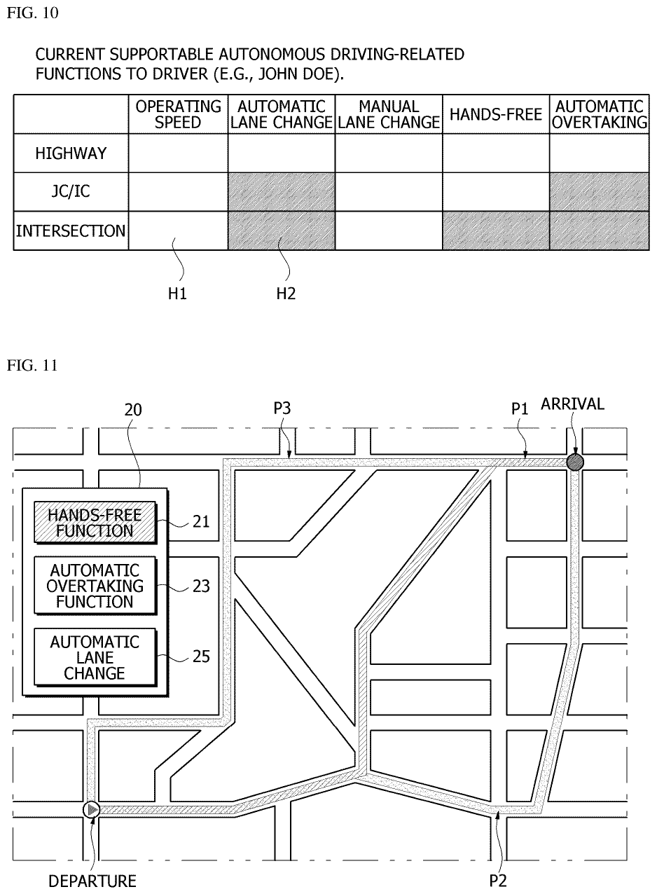

The autonomous driving control device 100 may display autonomous driving-related functions that may be supported by the current vehicle system according to the evaluation result of the driver engagement. For example, as illustrated in FIG. 10, the autonomous driving control device 100 may display a supported operational design domain (ODD) and an operating feature by classifying the ODD and the operating feature into activated windows H1 and deactivated windows H2.

FIG. 11 shows the contents of a map showing portions that may be provided for each autonomous driving operating feature if a navigation destination is selected. The driver may display each of items 21, 23, and 25 divided (e.g., determined, classified, detected, etc.) by operating feature in an application window 20. For example, if the hands-free function item 21 is selected (e.g., by a user), a route P1 through which the hands-free function may be supported may be displayed separately from other routes P2 and P3. In this way, the autonomous driving control device 100 may give a guide to a location that may be supported by the current engagement state score or grade (e.g., level) on the map with respect to the selected operating function.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

According to an aspect of the present invention, there is provided an autonomous driving control device including a memory configured to store information related to an engagement state of a driver and control information regarding an autonomous driving-related function and a processor configured to recognize the driver of a vehicle, evaluate the engagement state of the driver for an autonomous driving section accumulated by a vehicle system, and control the autonomous driving-related function according to an evaluated result.

In the autonomous driving control device according to some embodiments, the processor may evaluate the engagement state of the driver based on at least one of a hands-on state of the driver on a steering wheel and an eyes-on state related to a gaze of the driver during the autonomous driving section.

In the autonomous driving control device according to some embodiments, the processor may evaluate the engagement state of the driver based further on a cumulative number of warnings given to the recognized driver.

In the autonomous driving control device according to some embodiments, the hands-on state of the driver may include at least one of a grip region and a grip strength of the driver on the steering wheel, and the processor may evaluate the engagement state of the driver by applying different weights to the grip region and the grip strength.

In the autonomous driving control device according to some embodiments, the eyes-on state of the driver may include a state in which a gaze direction of the driver looks at any one of a first direction including a windshield of the vehicle, a second direction including a mirror of the vehicle, and a third direction excluding the windshield and the mirror, and the processor may evaluate the engagement state of the driver by applying different weights to the first direction, the second direction, and the third direction.

In the autonomous driving control device according to some embodiments, the processor may reset a result of the engagement state of the driver when a predetermined condition is met.

In the autonomous driving control device according to some embodiments, the processor may control the autonomous driving-related function according to the evaluated engagement state of the driver by controlling at least one of a warning to the driver, an autonomous driving operational design domain (ODD), and an autonomous driving operating feature.

In the autonomous driving control device according to some embodiments, the processor may generate a plurality of groups that are distinguished from each other by combining the autonomous driving operational design domain (ODD) and the autonomous driving operating feature, and determine whether to support at least one of the generated groups depending on the evaluated engagement state of the driver.

In the autonomous driving control device according to some embodiments, the processor may evaluate the engagement state of the driver for the autonomous driving for each sub-section of the autonomous driving section or for each autonomous driving operating feature and control the autonomous driving-related function according to an evaluated result.

In the autonomous driving control device according to some embodiments, the processor may display at least one of the evaluated engagement state of the driver and an autonomous driving control state according to the engagement state through an input/output interface.

In the autonomous driving control device according to some embodiments, the processor may divide the engagement state of the driver into indicators that are distinguished from each other and displays at least one of the indicators through the input/output interface, in which the indicators may include first indicator indicating a hands-on state of the driver, a second indicator indicating an eyes-on state of the driver, a third indicator indicating a cumulative number of warnings given to the driver, and a fourth indicator indicating a score or grade of the engagement state of the driver.

In the autonomous driving control device according to some embodiments, the processor may distinguish and display at least some of a plurality of routes for a specific destination for each supportable autonomous driving operating feature when a navigation route request for the specific destination is received.

In the autonomous driving control device according to some embodiments, the processor may transmit at least one of the engagement state of the driver and the autonomous driving control state according to the engagement state to a terminal of the recognized driver through a communication unit.

According to another aspect of the present invention, there is provided a method of controlling autonomous driving of a vehicle, including recognizing a vehicle driver, evaluating an engagement state of a driver for an autonomous driving section accumulated by a vehicle system, and controlling an autonomous driving-related function of the vehicle according to an evaluated result.

In the method according to some embodiments, in the evaluating of the engagement state of the driver, the engagement state of the driver may be evaluated based on at least one of a hands-on state of the driver on a steering wheel and an eyes-on state related to a gaze of the driver during the autonomous driving section.

In the method according to some embodiments, in the evaluating of the engagement state of the driver, the engagement state of the driver may be evaluated based further on a cumulative number of warnings given to the recognized driver.

In the method according to some embodiments, the hands-on state of the driver may include at least one of a grip region and a grip strength of the driver on the steering wheel, and in the evaluating of the engagement state of the driver, the engagement state of the driver may be evaluated by applying different weights to the grip region and the grip strength.

In the method according to some embodiments, the eyes-on state of the driver may include a state in which a gaze direction of the driver looks at any one of a first direction including a windshield of the vehicle, a second direction including a mirror of the vehicle, and a third direction excluding the windshield and the mirror, and in the evaluating of the engagement state of the driver, the engagement state of the driver may be evaluated by applying different weights to the first direction, the second direction, and the third direction.

The method according to some embodiments may further include resetting a result of the engagement state of the driver when a predetermined condition is met.

In the method according to some embodiments, in the controlling of the autonomous driving-related function, at least one of a warning to the driver, an autonomous driving operational design domain (ODD), and an autonomous driving operating feature may be controlled.

According to an embodiment of the present disclosure, by evaluating a driver engagement state in an accumulative autonomous driving section and controlling an autonomous driving-related function based on the evaluation, a customized autonomous driving environment according to the user engagement state can be provided.

In addition, by providing a driver with information on the evaluated driver engagement state and control of the autonomous driving-related function, the driver can actively improve his or her engagement state for autonomous driving.

Effects of the present disclosure are not limited to those mentioned above, and other effects not mentioned will be clearly understood by those of ordinary skill in the art from the description below.

Although the preferred embodiments of the present disclosure have been described above, it is understood that those skilled in the art can make various changes and modifications to the present disclosure without departing from the spirit and scope of the present disclosure set forth in the claims below.

What is claimed is:

1. A driving automation device comprising:
a processor; and
a memory storing:
an engagement state of a driver of a vehicle; and
control information associated with one or more autonomous driving functions of the vehicle,
wherein the memory further stores at least one instruction that is configured, when executed by the processor communicating with the memory, to cause the driving automation device to:
recognize, via at least one sensor of the vehicle, the driver of the vehicle;
evaluate, based on the control information associated with the one or more autonomous driving functions, the engagement state of the driver for an autonomous driving portion of a trip, of the vehicle, during which the one or more autonomous driving functions of the vehicle are activated; and
control, based on the engagement state, the one or more autonomous driving functions of the vehicle.

2. The driving automation device of claim 1, wherein the at least one instruction is configured, when executed by the processor communicating with the memory, to cause the driving automation device to evaluate the engagement state of the driver by:
evaluating the engagement state of the driver based on at least one of:
a steering wheel grip status of the driver during the autonomous driving portion of the trip, or
an eye gaze status of the driver during the autonomous driving portion of the trip.

3. The driving automation device of claim 2, wherein the steering wheel grip status of the driver indicates a grip region on a steering wheel of the vehicle and a grip strength of the driver on the steering wheel, and
wherein the at least one instruction is configured, when executed by the processor the processor communicating with the memory, to cause the driving automation device to evaluate the engagement state of the driver by applying different weights to the grip region and the grip strength.

4. The driving automation device of claim 2, wherein the eye gaze status indicates: a first time duration during which the driver gazed in a first direction toward a windshield of the vehicle, a second time duration during which the driver gazed in a second direction toward a mirror of the vehicle, and a third time duration during which the driver gazed in any third direction that is away from the first direction and the second direction, and
wherein the at least one instruction is configured, when executed by the processor the processor communicating with the memory, to cause the driving automation device to evaluate the engagement state of the driver by applying different weights to the first time duration, the second time duration, and the third time duration.

5. The driving automation device of claim 1, wherein the at least one instruction is configured, when executed by the processor communicating with the memory, to cause the driving automation device to evaluate the engagement state of the driver by:
evaluating the engagement state of the driver based on a number of warnings given to the driver during the autonomous driving portion of the trip.

6. The driving automation device of claim 1, wherein the at least one instruction is configured, when executed by the processor communicating with the memory, to further cause the driving automation device to:
reset, based on a predetermined condition being satisfied, the engagement state of the driver.

7. The driving automation device of claim 1, wherein the one or more autonomous driving functions are associated with at least one of: a warning to the driver, an autonomous driving operational design domain (ODD) of the vehicle, steering the vehicle, accelerating the vehicle, or braking the vehicle.

8. The driving automation device of claim 1, wherein the at least one instruction is configured, when executed by the processor communicating with the memory, to further cause the driving automation device to:
determine a plurality of autonomous driving ODDs of the vehicle, each autonomous driving ODD of the plurality of autonomous driving ODDs being associated with a different set of the one or more autonomous driving functions; and
determine, based on the engagement state of the driver, whether to support at least one of the plurality of autonomous driving ODDs.

9. The driving automation device of claim 1, wherein the at least one instruction is configured, when executed by the processor communicating with the memory, to cause the driving automation device to evaluate the engagement state of the driver by:
evaluating an engagement state for each sub-portion, of the autonomous driving portion, during which a corresponding autonomous driving function of the one or more autonomous driving functions was activated, and
wherein the at least one instruction is configured, when executed by the processor communicating with the memory, to cause the driving automation device to control the one or more autonomous driving functions of the vehicle by:
controlling, based on the engagement state for each sub-portion of the autonomous driving portion, the corresponding autonomous driving function.

10. The driving automation device of claim 1, wherein the at least one instruction is configured, when executed by the processor communicating with the memory, to further cause the driving automation device to:
display, via a user interface, at least one of the engagement state of the driver or an autonomous driving control state of the vehicle according to the engagement state.

11. The driving automation device of claim 10, wherein the at least one instruction is configured, when executed by the processor communicating with the memory, to cause the driving automation device to display the engagement state of the driver by:
displaying, via the user interface, at least one of:
a first indicator of a steering wheel grip status of the driver;
a second indicator of an eye gaze status of the driver;
a third indicator of a number of warnings given to the driver; or
a fourth indicator of a value of the engagement state of the driver.

12. The driving automation device of claim 10, wherein the at least one instruction is configured, when executed by the processor communicating with the memory, to cause the driving automation device to:
display, based on receiving a routing request for a destination, one or more routes to reach the destination, wherein each of the one or more routes is associated with a corresponding autonomous driving function of the one or more autonomous driving functions.

13. The driving automation device of claim 1, wherein the at least one instruction is configured, when executed by the processor communicating with the memory, to further cause the driving automation device to:
transmit, via a communication interface of the vehicle and to a terminal associated with the driver, at least one of the engagement state of the driver or an autonomous driving control state of the vehicle according to the engagement state.

14. A method performed by an apparatus of a vehicle, the method comprising:
recognizing, via at least one sensor of the vehicle, a driver of the vehicle;
evaluating, based on control information associated with one or more autonomous driving functions of the vehicle, an engagement state of the driver for an autonomous driving portion of a trip, of the vehicle, during which the one or more autonomous driving functions of the vehicle are activated; and
controlling, based on the engagement state, one or more autonomous driving functions of the vehicle.

15. The method of claim 14, wherein the evaluating of the engagement state of the driver comprises:
evaluating the engagement state of the driver based on at least one of:
a steering wheel grip status of the driver during the autonomous driving portion of the trip, or
an eye gaze status of the driver during the autonomous driving portion of the trip.

16. The method of claim 15, wherein the steering wheel grip status of the driver indicates a grip region on a steering wheel of the vehicle and a grip strength of the driver on the steering wheel, and
wherein the evaluating of the engagement state of the driver comprises applying different weights to the grip region and the grip strength.

17. The method of claim 15, wherein the eye gaze status indicates: a first time duration during which the driver gazed in a first direction toward a windshield of the vehicle, a second time duration during which the driver gazed in a second direction toward a mirror of the vehicle, and a third time duration during which the driver gazed in any third direction that is away from the first direction and the second direction, and
wherein the evaluating of the engagement state of the driver comprises applying different weights to the first time duration, the second time duration, and the third time duration.

18. The method of claim 15, wherein the evaluating of the engagement state of the driver comprises evaluating the engagement state of the driver based on a number of warnings given to the driver during the autonomous driving portion of the trip.

19. The method of claim 14, further comprising:
resetting, based on a predetermined condition being satisfied, the engagement state of the driver.

20. The method of claim 14, wherein the one or more autonomous driving functions are associated with at least one of: a warning to the driver, an autonomous driving operational design domain (ODD) of the vehicle, steering the vehicle, accelerating the vehicle, or braking the vehicle.
